(19) United States
(12) Patent Application Publication
(10) Pub. No.: US 2010/0147599 A1
(43) Pub. Date: Jun. 17, 2010

(54) Counting Scale with Multilevel Hinkley Detector

(76) Inventors: Roland Nägele, Insel Reichenau (DE); Wolfram Luithardt, Belfaux (CH)

Correspondence Address: WINSTEAD PC, P.O. BOX 50784, DALLAS, TX, 75201, US

(21) Appl. No.: 12/226,514

(22) PCT Filed: Feb. 2, 2007
(86) PCT No.: PCT/CH2007/000054

§ 371 Date: Sep. 15, 2009

(30) Foreign Application Priority Data
Apr. 21, 2006 (CH) 652/06

(51) Int. Cl. G01G 19/42

(52) U.S. Cl. 177/25.17

(57) ABSTRACT

Counting scale with a multilevel Hinkley detector that can recognize the jumps of a very noisy signal s(t) from an average value (standard level) to a new average value. The measured signal s(t) is tested for several hypothetical jump sizes m₁ at the same time. A test value h₁(t) is established for every jump size using a nonlinear recursive algorithm. By recognizing which test value h₁(t) first reaches a threshold value ε, the number of parts that have been added and if necessary removed can be determined.

The present invention relates to a counting scale used as a mass or force sensor according to the preamble of claim 1.

Counting scales are known and are frequently used. If a number n of parts are to be counted and counting them is too costly, for example because n is large, then counting scales are used. Frequently the so-called division method is applied. In this method the container is weighed with the parts, the container weight is subtracted and the net weight divided by the weight of a single piece. This method fails however when the weight of the part is not precisely known or varies widely from part to part. Therefore, for example at an inaccuracy of +/−5%, from as few as 11 parts it can no longer be assumed that the calculated quantity is correct. This maximum number of parts which can be determined reliably is given by the formula

nₘₐₓ=(1+d)/2d,

where d is the determined or known inaccuracy. This value is independent of the weight of the parts.

In order to overcome this disadvantage of the division method, algorithms have been developed in production engineering which analyse the weight as it increases due to parts being placed on the scale, and assigns it to a whole number of parts. These methods are known and successfully deployed, but they fail when a large number of parts is placed on the scale at the same time, or the noise level of the scale (i.e. the standard deviation of the measurement values) is of the same order of magnitude as the weight of a part. If the measurement values are so severely affected by noise, any jump occurring, caused by adding another part, can no longer be recognised with confidence; it is masked by the noise.

The problem addressed by the invention consists in reliably counting even those parts with varying part weight and to be able to evaluate measurement values severely affected by noise with confidence.

The solution to the problem is reproduced in the characterising part of claim 1 with reference to its main features, and in the dependent claims with reference to additional advantageous features.

Using the attached drawings and by means of mathematically supported consideration the invention will now be explained in further detail. Shown are:

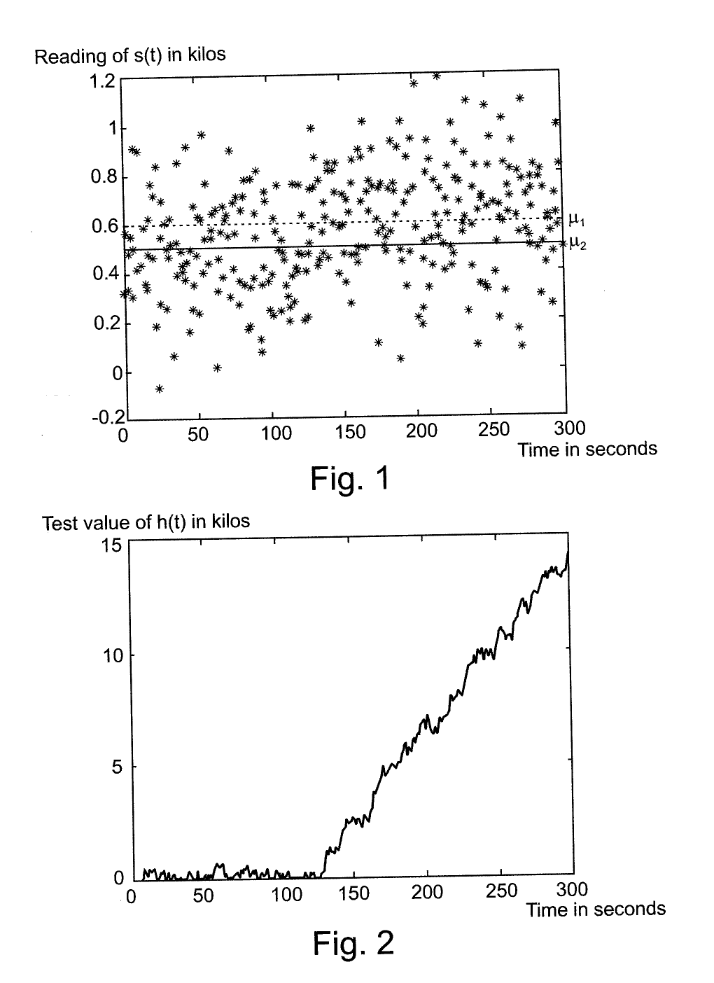

FIG. 1 a series of individual measurement results s(t) of the mass of a first and an additional object,

FIG. 2 the temporal behaviour of a test value h,

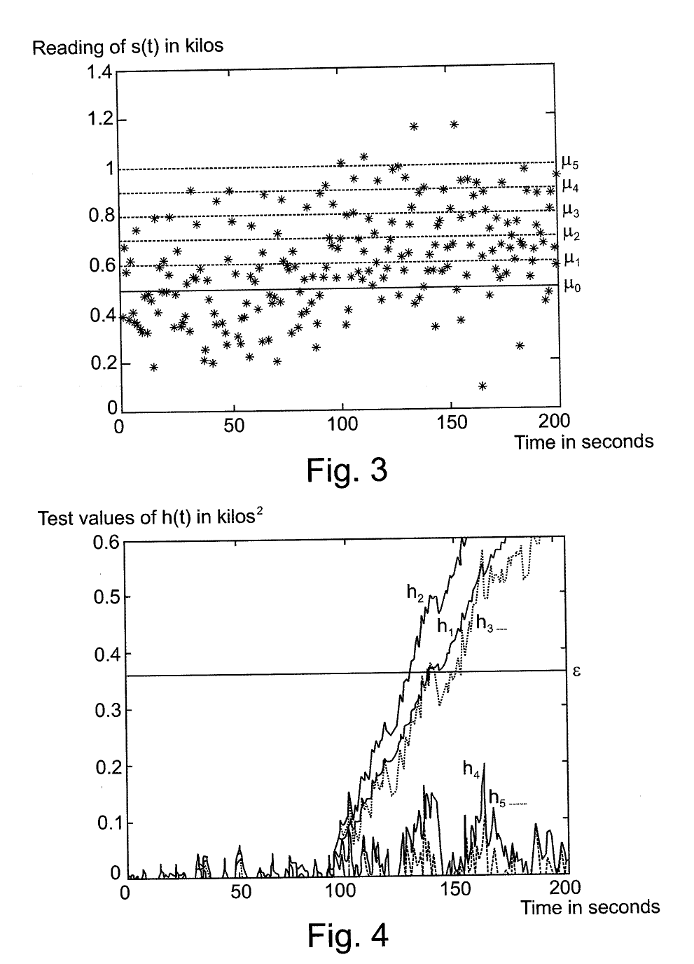

FIG. 3 measurement values and jump levels for various numbers of parts,

FIG. 4 the temporal behaviour of test values hᵢ for various numbers of parts.

Every measurement system is subject to noise; internally due to thermal noise, discretisation errors and other system-dependent deviations between consecutive measurement results of the same object; externally due to disturbances in the environment. This second external contribution to the noise is precisely the dominant one in the case of scales, and substantially exceeds the internal component. The perturbation of the scales itself further contributes to the lack of accuracy. In general such scales are equipped with a rest position control, which as a rule however has a greater permitted bandwidth than the statistical variations that arise due to the perturbation, regarded as normal. For this reason consecutive weighing results deviate from one another within a permitted bandwidth, the statistical noise. This is true for all scales, regardless of the principle used to determine force or mass.

In order to detect a possibly occurring jump by an amount approximately known in advance in very noisy data—which in the following invention take the form of weight values—, a so-called Hinkley detector [R. Schultze: “Jump recognition for the system identification of ships and for the analyse of patch-clamp data”, VDI Progress Reports, Series 8: Measurement Technology and Control Engineering, No. 347, VDI-Verlag, Dusseldorf, 1993] is used. This allows both reliable counting of parts as well as zero-point tracking of the scale, which is necessary due to slow creepage of the scale or other effects, e.g. temperature changes.

FIG. 1 shows, in a first example, such a series of noisy measurement values s(t). μ₀ is the initial mean value, μᵢ the value after placement of a part.

The Hinkley detector is the implementation of an algorithm which is intended to recognise a jump from one mean value μ₀ of a sampled signal to another known mean value μ₁=μ₀+m (m>0). As in most theoretical derivations the noise on the signal is initially assumed to be white and normally distributed; also, the variance σ² does not change when a jump occurs. The Hinkley detector also works under small relaxations of these assumptions.

The Hinkley detector decides whether, in a series of sampled values s(t), a jump has occurred from the mean value μ₀ to the mean value μ₁=μ₀+m. The height of the jump m is determined a priori from the mean of the weights of a sufficient number of parts to be counted. If such a jump has occurred, then the Hinkley detector delivers an estimate of the time the jump occurred.

The method presupposes that the mean values μ₀ and the expected increase m are known in advance. If a measurement value s(t) is higher than the value μ₀+m/2, this indicates a jump, and if it is lower, this indicates that no jump has taken place. The difference of a measured value s(t) from the value μ₀+m/2 is designated with the term d(t):

d(t)=s(t)=μ₀−m/2=e(t)−m/2,

where the quantity e(t)=s(t)−μ₀ is also known as the innovation.

From these values, the Hinkley detector forms the cumulative sum

$$S ( t ) = {\sum }_{k = 0}^{t} d ( t )$$

and from this, determines at each sampling step the previous minimum:

$$M ( t ) = {min}_{k = 0 … t} S ( k )$$

Before a jump, d(t)<0 is true, therefore S(t) is getting smaller. As long as S(t) is falling, M(t)=S(t). After a jump it is mostly the case that d(t)>0, therefore S(t) is growing. If S(t) increases after a jump, M(t) retains its previous value. M(t) is therefore the global minimum of the previous values S(t). The difference between S(t) and M(t) is the decisive value, the test value h(t) for the detection of a jump:

h(t)=S(t)−M(t)

FIG. 2 shows the temporal behaviour of a test value h(t). If h(t) exceeds a specified threshold value ε, this is taken as a criterion for the detection of a jump. For the jump time an estimate is made of the time at which S(t) was previously a minimum, i.e. h(t)=0 was true. Short, small increases in h(t) occur if, due to the noise, s(t) is ever greater than μ₀+m/2. However, if a jump has taken place, h(t) rises rapidly and markedly. The threshold value ε must be chosen large enough so that h(t) does not exceed it due to brief noise induced rises (no false alarms) and small enough so that after a jump the threshold is rapidly exceeded and the jump is therefore detected. It is not possible to detect a jump immediately, since an increase in h(t) or S(t) alone is not a sufficient criterion; only a fairly sharp increase should be regarded as a jump. If the threshold value ε is chosen to be larger, then the time taken to detect a jump also increases. The probability that a jump is detected, although none has occurred (false alarm), tends rapidly to 0 however. The mean time until a false alarm increases exponentially, but the delay before a jump is detected only at a rate proportional to s. By the choice of a relatively large ε a false alarm can be almost completely eliminated, without the time taken to detect of a jump becoming impractically long. By the choice of a suitable ε the algorithm can be adapted to the demands of the application.

For online-processing the calculation steps can be implemented in a recursive fashion. After initialisation with h(0)=0 the values s(t) are traversed step by step and each time the two following calculations are performed:

Form the cumulative sum:

h*(t)=h(t−l)+s(t)−μ₀−m/2

Eliminate negative values:

h(t)=h*(t), if h*(t)>0

h(t)=0, if h*(t)≦0

As long as no jump has taken place, h(t) deviates only a negligible amount from 0. From the instant of a jump however it begins to increase, until ε is reached and a jump is therefore detected.

In order to extend the method of jump recognition according to Hinkley to cover temporally varying m=m(t) as well, Schultze [Schultze op. cit.] and Hansen et al. [“Detecting events in signals from sensors: the Hinkley-detector is the answer.” Sensors and Materials 7, No. 4 (1995), pp. 289-300] introduced a measure of the increase in the cumulative sum that is dependent on the variable m(t).

h*(t)=h(t−1)+m(t)/2*(e(t)−m(t)/2).

The greater the value of m(t), the more sharply h(t) will rise. This is the so-called “Dynamic Hinkley Detector” (DHD), which deals with the treatment of jump levels which vary with time. Evaluating the difference of innovation and m(t)/2 with respect to m(t)/2 obtains the result that the threshold ε, on exceeding which the jump is detected, can remain constant for all m(t), and therefore all m(t), independently of the absolute value, are detected with equal reliability.

In the present invention then, it is not one time-varying m(t) that is considered, but multiple parallel mᵢ (so-called Multilevel Hinkley Detector MLHD). After every new weight measurement, for every i the corresponding test value sum hᵢ(t) is calculated. The index i here is used for assigning the test value hᵢ(t) to the mᵢ. An example for illustration purposes is given in FIG. 3.

FIG. 3 is a plot of measurement values s(t) and mean values μ₀+mᵢ (i=0 . . . 5, mᵢ=i*m, m=weight per part) for a postulated weight per part m of 0.1 kg. Concretely, at t=90s two such parts @ 0.1 Kg each are placed on the scale. Here s(t) jumps from μ₀ to the new level μ₀+m₂.

FIG. 4 shows the graphs of the test values for this example. h₁ (solid), h₂ (solid) and h₃ (dashed) increase continuously, apart from short noise induced drops, h₄ (solid), and h₅ (dashed-dotted) only deviate from 0 due to noise. h₂ is the first to exceed ε, which means the MLHD has identified a jump to the new level μ₀+m₂.

The larger the actual jump size mᵢ, the more quickly hᵢ (t) grows and the more quickly it reaches the threshold ε. Since large jumps rarely occur due to normally distributed noise, the probability of a false alarm here is small. At small mᵢ more steps are necessary to reach ε; the error probability here is also small.

On every iteration a check is only carried out for the largest hᵢ(t) as to whether it has already exceeded the threshold ε. By the use of the MLHD it becomes possible to check many different jump sizes in parallel and, depending on the specific application, to analyse them. Thus for example, as well as the placing of a single part, the simultaneous placing of several parts can also be detected. Removal of parts can be determined by using negative mᵢ. By using other mᵢ, jumps can be detected which do not correspond to an integer multiple of the weight of the part. In this manner, incorrect weights can be detected and appropriately handled (e.g. by issuing a warning to the operator of the scale, stoppage of the production system etc.) By using a small mᵢ (mᵢ<<mₚₐᵣₜ_{_{—}}_{weight}), a zero correction can even be implemented. If such a rare event (due to the smallness of mᵢ and the associated long period of time taken to reach ε) should occur, it is then assumed that the zero point of the scale has changed due to creepage, contamination of the scale platform, temperature changes etc., and this can be corrected accordingly.

1. Method for implementing in a computer of a counting scale for recognising jumps in the weights placed on said counting scale,
characterized in that
a detector implemented in the computer (Hinkley detector) is present, in which the following computing steps are performed:
from a number of consecutively measured weight values s(t) a first mean μ₀ is formed,
a second value, the weight of a part m, is entered, which corresponds to the expected weight of a part to be counted,
the deviation of the new measurement value s(t) from the value μ₀ is formed, called innovation e(t),
a test value h(t) is formed, by after each measurement recursively adding the innovation minus half of the part weight multiplied by half the part weight, and in the event of a negative result setting it to zero,
it is determined whether h(t) is greater than a pre-specified threshold value ε,
if h(t)>ε, a jump is detected and this result is processed further.

2. Method according to claim 1,
characterized in that
the detector is modified in such a way that multiple mᵢ are considered at the same time (Multilevel Hinkley Detector MLHD), which means that the simultaneous placing or removal of multiple parts can be detected, and that this is achieved by introducing mᵢ-specific test values h(t) and comparison of the largest h(t) at a given instant with ε.

3. Method according to claim 2,
characterized in that
by using a small mₖ (mₖ<<m), a zero-point correction can be implemented.

4. Method according to claim 2,
characterized in that
by using further mᵢ, placements of weights can be detected which do not correspond to the addition or removal of whole parts (faulty parts).

5. Counting scale with a computer and a display,
characterized in that
the computer contains at least one implemented Hinkley detector.

6. Counting scale according to claim 5,
characterized in that
the scale contains at least one implemented multi-level Hinkley detector and can therefore determine and display whether more than one part to be counted is placed on or removed from the counting scale.

7. Counting scale according to claim 5 or 6,
characterized in that
the type of scale is one which determines the weight placed thereon by means of the vibration frequencies of vibrating strings.
